(19) United States
(12) Patent Application Publication
(10) Pub. No.: US 2005/0110765 A1
(43) Pub. Date: May 26, 2005

(54) Apparatus and method for capturing site data while scuba diving

(76) Inventor: Daniel M. Baeza, Coral Springs, FL (US)

Correspondence Address: CANTOR COLBURN LLP, 55 GRIFFIN ROAD SOUTH, BLOOMFIELD, CT, 06002, US

(21) Appl. No.: 10/718,736

(22) Filed: Nov. 21, 2003

(51) Int. Cl. G09G 5/00

(52) U.S. Cl. 345/173

(57) ABSTRACT

The apparatus includes a watertight main body and a display screen disposed on the main body. The display screen has a writing pad, which receives information by applying a pressure to the writing pad. An auto-equalizing device is disposed in the main body to ensure that the writing pad remains equalized underwater. A method for capturing site data includes activating an apparatus that has a watertight main body and a display screen disposed on the main body. The display screen has a writing pad, which receives information by applying a pressure to the writing pad. An auto-equalizing device is disposed in the main body to ensure that the writing pad remains equalized and operational underwater. The method also includes alternating between a first mode and a second mode and inputting information through the writing pad.

### FIELD OF THE INVENTION

The present disclosure relates generally to integrating a real-time recording capability with the dive computer.

### BACKGROUND OF THE INVENTION

Personal digital assistants (PDAs) currently provide a wide variety of productivity applications, such as a calendar, an address book, notes and memos, and an extensive memory in a convenient, hand held form. One of the most popular current PDA's is the Palm™ Handheld manufactured by Palm, Inc.

PDA designs have recently been improved to incorporate a number of features previously found only in traditional laptop or desktop computers. For example, many recent PDAs have touch sensitive screens that allow a user to quickly and efficiently enter information by touching a stylus to the screen. The PDAs may employ a user-friendly graphical user interface such as a Windows™ or Windows™ CE interface. In addition, the user may write messages directly on the screen using the stylus. The image produced may be transmitted via electronic mail or facsimile or may simply be stored in memory. With the advances in handwriting recognition, the PDA can interpret the writing and convert it into a text format.

Scuba divers record information about their dives in a logbook at the conclusion of each dive. Some of the information recorded is as follows: (1) name of the dive site; (2) parametric data such as depth and duration (3) location; (4) weather conditions; and (5) other observations. This log is used to validate the diver's experience level and provide a “dive profile” in the event of a medical emergency, as well as create a diary of the event. Often, the environment is too harsh to create a written record immediately after the conclusion of the dive and is deferred until later in the day. As a consequence, if the dive is recorded at all, much of the pertinent information is forgotten.

In addition, many divers now use dive computers to measure depth, elapsed time, temperature, and most importantly, no-decompression limits. All information is displayed on a water-resistant liquid crystal display screen carried with the diver underwater.

There also exists underwater writing slates that are plastic slabs and are not connected with a dive computer. Divers are able to capture dive information while underwater; however, this information needs to be transcribed to the permanent logbook after the dive is completed.

There also exists an underwater diving assistant, which uses a pen digitizer that has been modified to operate underwater at a depth. However, due to the use of a pen digitizer, the product is more complicated to make and as a result, is very expensive.

### SUMMARY OF THE INVENTION

Disclosed herein is an apparatus and method for capturing site data while scuba diving. The apparatus includes a watertight main body and a display screen disposed on the main body. The display screen has a writing pad, which receives information by applying a pressure to the writing pad. An auto-equalizing device is disposed in the main body to ensure that the writing pad remains equalized underwater. A method for capturing site data includes activating an apparatus that has a watertight main body and a display screen disposed on the main body. The display screen has a writing pad, which receives information by applying a pressure to the writing pad. An auto-equalizing device is disposed in the main body to ensure that the writing pad remains equalized underwater. The method also includes alternating between a first mode and a second mode and inputting information through the writing pad.

Other apparatus and methods according to embodiments will be or become apparent to one with skill in the art upon review of the following drawings and detailed description. It is intended that all such additional apparatus and methods be within the scope of the present invention, and be protected by the accompanying claims.

### BRIEF DESCRIPTION OF THE DRAWINGS

Referring now to the figures, which are exemplary embodiments and wherein the like elements are numbered alike:

FIG. 1 is a front view of a hand held unit, which includes a dive computer with a writing pad incorporated therein in accordance with exemplary embodiments of the present invention;

FIG. 2 is a side view of the hand held unit in accordance with exemplary embodiments of the present invention;

FIG. 3 is a flow diagram of a method for operating the hand held unit of FIG. 1 in accordance with exemplary embodiments of the present invention; and

FIG. 4 is a block diagram of the hand held unit of FIG. 1 connected to a personal computer and to the Internet.

### DETAILED DESCRIPTION OF THE INVENTION

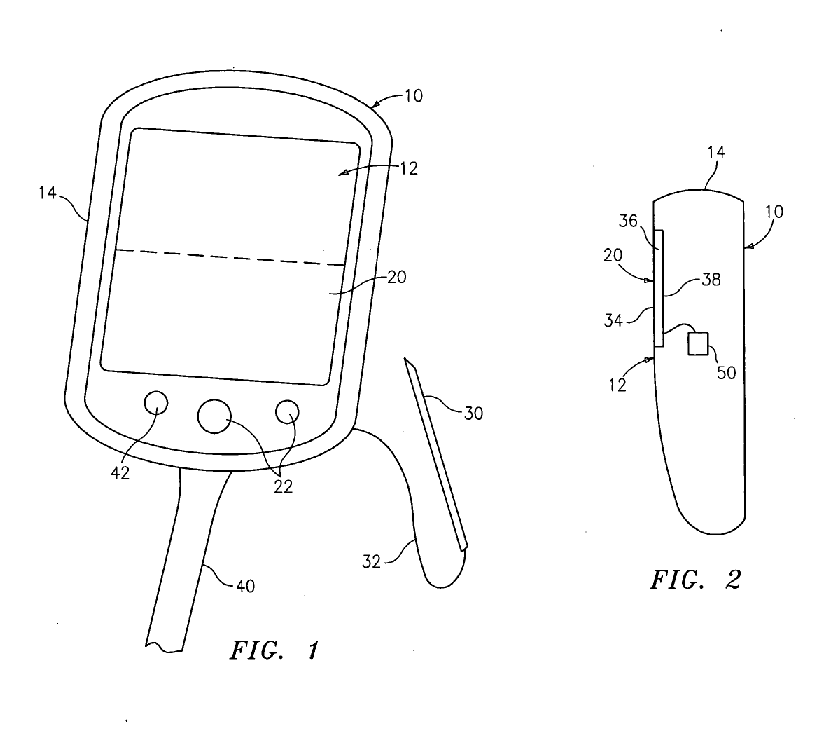

FIGS. 1 and 2 illustrate a hand held unit 10, which has a display screen 12 and a main body 14. The display screen 12 has a writing pad 20 that can be incorporated into an area of the display, or can be incorporated into the entire display. Hand held unit 10 also incorporates all of the standard functions of a dive computer. For example, just like a dive computer, the hand held unit 10 is watertight and can be exposed to harsh environments, such as an underwater environment, rain, sleet, and snow.

Hand held unit 10 includes a metallic, passive stylus 30, which is used to write messages, such as location, weather conditions, and site notes, on the writing pad 20. The stylus 30 is passive because the stylus does not require an electronic connection or signal to operate. Instead, the writing pad 20 operates by pushing the stylus 30 against the writing pad 20 so as to apply a pressure to the writing pad 20.

The stylus can be stored in a known manner, as part of the handheld unit 10. The stylus 30 is used to draw or write on the writing pad 20 as an ordinary pen and conveys the information to the writing pad 20 through pressure on the writing pad 20. The stylus 30 can be attached by a string 32 to the hand held unit 10. The string 32 serves no other purpose than to assure that the stylus 30 does not get lost, especially when using the handheld unit 10 in a harsh environment.

Writing pad 20 works through pressure applied to the screen by the stylus 30. Pressure sensitive touch pads are commonly used with PDAs and other portable electronic devices. Pressure sensitive touch pads convert mechanical pressure into an electrical output.

Writing pad 20 includes a resistive touchscreen that includes a flexible top sheet 34, a small gap 36, and a glass base 38. Similar to all resistive touchscreens, the top sheet 34 and the glass base 38 are separated by insulating dots (not shown). The top sheet 34 is coated with a variable-resistance elastomer (not shown), and the glass base 38 is coated with a transparent metal oxide (not shown) on their inside surfaces (on either side of the gap 36). A voltage gradient is applied across the glass base 38. Pressing on the flexible top sheet 34 creates a resistive electrical contact between the top sheet 34 and the glass base 38, allowing a current flow. The writing algorithm interprets the x-y coordinates of the contact. The gap 36 is extremely narrow and generally, not more than 0.005 inches. To facilitate the writing process, predictive text employing artificial intelligence techniques can be incorporated into the writing algorithms.

When a diver descends underwater, the pressure of the environment increases and pressure is applied to the writing pad 20. Accordingly, because of the gap 36, the outside screen 34 will have a tendency to push into the gap 36 and contact inside screen 38. If this occurs, then the screen will mark because the screen will interpret the pressure as information being inputted.

In order to ensure that this does not happen and to ensure that the writing pad 20 can function in such an environment, and also to ensure that marks do not appear on writing pad 20 from the ambient water pressure applied to the writing pad 20, the gap 36 must be automatically equalized. The gap 36 is automatically equalized electronically by an auto-equalizing device 50. The auto-equalizing device 50 is implemented by hardware and/or software and works by comparing the voltage gradient against the pressure gradient reported by the pressure sensor, and an offset current relative to the depth is computed. The offset current is updated as the depth changes. Accordingly, writing is detected with reference to the offset current and the writing pad 20 is able to work underwater even as the water pressure vanes.

Main body 14 is made of a durable material that can withstand harsh environments, such as an underwater environment. In order for the main body 14 to withstand an underwater environment and the pressure associated with such an environment, main body 14 has minimal air pockets contained within the main body. For instance, with the exception of the gap 36, the main body 14 may be filled with a layer of silicon-based gel or some other inert material to fill any air pockets.

Hand held unit 10 includes standard controls 22, which are usually found on a dive computer and which operate the dive computer. The standard controls 22 may also include a keyboard, such as the keyboards located on known PDAs. Hand held unit 10 can be attached to a high pressure hose 40 or can be a stand alone unit that can be attached to the diver in some known manner, i.e., a wrist band, etc.

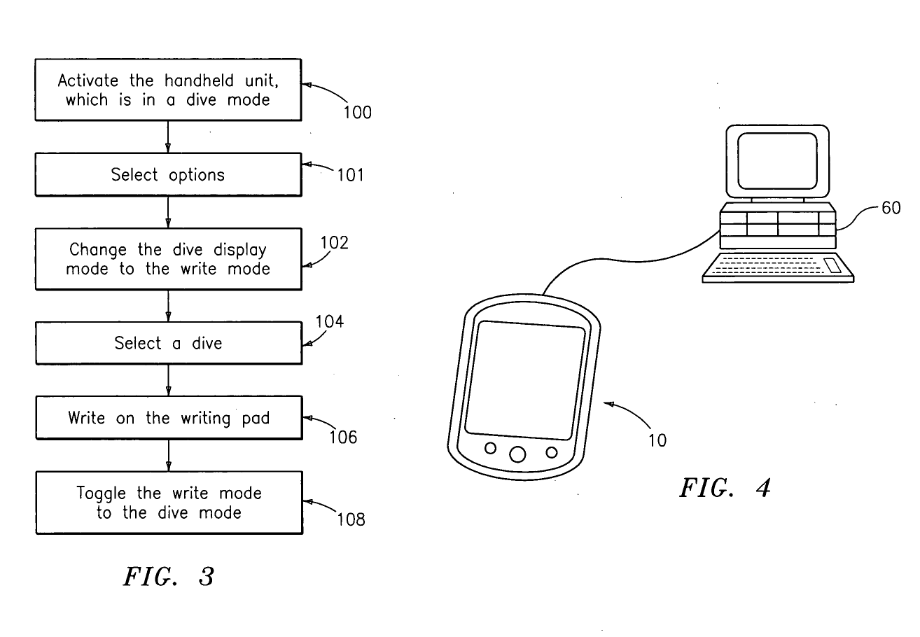

Referring to FIGS. 1-3, a flow diagram illustrates a method for capturing site data. At step 100, hand held unit 10 is activated or turned on. Hand held unit 10 has two modes: (1) write mode; and (2) dive mode. When the hand held unit 10 is activated, either the write mode or the dive mode may be activated. For illustrative purposes, this flow diagram illustrates that the hand held unit 10 is initially in dive mode when the hand held unit is activated.

Accordingly, step 100 also illustrates that the hand held unit 10 is in dive mode. At step 101, the user may initiate some customizing options. Such customizing options include (1) toggle predictive text mode, (2) activate calculator, and (3) change default dive profile template.

At step 102, dive mode is changed to write mode. There are two ways that the hand held unit 10 can change from write mode to dive mode and vice versa. The first way is to tap on the writing pad 20 with the stylus 30 a plurality of times in a short time interval, which will activate the write mode. Exemplary embodiments illustrate that the user will hold the stylus 30 and tap on the writing pad 20 four times within two seconds to activate the write mode. Alternatively, the hand held unit 10 can change from dive mode to write mode by pressing a button 42 located on the handheld device 10, which will switch the mode from dive to write and vice versa.

At step 104, once the write mode is activated, the user can choose one of the stored dives by selecting a dive number or by selecting a current dive for the most recent dive. At step 106, the user then draws and/or writes on the writing pad 20 with the stylus 30 to record the pertinent data. At step 108, once all the data has been entered, the hand held unit 10 is placed back in dive mode. Exemplary embodiments illustrate that the user taps the writing pad 20 with the stylus 30 a plurality of times in a short time interval to deactivate the write mode and return the hand held unit 10 to the dive mode 44. The user may also push the button 42 to return the hand held unit 10 to dive mode. Alternatively, the write mode will time out after a predetermined period of inactivity on the writing pad 20.

Hand held unit 10 includes all of the functions of a standard dive computer. Examples of standard dive computer functions are the Oceanic DataMax dive computer, which incorporates a water tight computer that can automatically compensate for altitude up to 14,000 feet, giving adjusted no-decompression times and depths. The computers also automatically recalibrate the depth display for freshwater instead of seawater. The dive computer also has replaceable batteries. The dive computers can calculate current depth, tank pressure, the diver's breathing rate, ascent time, and decompression status to tell the diver exactly how much time the diver can remain underwater.

While one of the most common dive computers are attached to a high pressure hose, there also exists dive computers with hoseless transmission. Dive computers have the ability to offer hoseless transmission of dive information with a full array of features.

After a dive is complete, the hand held unit 10 contains information regarding that specific dive. The information can be viewed on the hand held unit 10 via software that is included on the hand held unit 10. In addition or alternatively, the hand held unit 10 includes means for downloading that information, such as a USB port and/or an infrared port, to a personal computer 60 (see FIG. 4) or to another PDA. There is software that is loaded on either the personal computer, the PDA, and the hand held unit 10, which activates the upload of the data from the hand held unit 10 to the other computer. That software then displays or reports the data of the specific dive.

The software that is loaded on the hand held unit 10, personal computer, and/or PDA provides intuitive post-dive analysis and logging. The software allows the diver to add and/or edit many pieces of information to customize the logbook, with data such as depth and decompression status during a dive, maximum depth, bottom time, air consumption, air time remaining, no-decompression status, descent and ascent rate, surface interval, and any violations recorded automatically.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to a particular embodiment disclosed as the best mode contemplated for carrying out this disclosure, but that the disclosure will include all embodiments falling within the scope of the appended claims.

1. An apparatus for capturing site data, the apparatus comprising:
a watertight main body;
a display screen disposed on the main body;
a writing pad incorporated as part of the display screen; and
an auto equalizing device disposed in the water tight main body, wherein the writing pad receives information by applying a pressure to the writing pad.

2. The apparatus of claim 1, wherein the auto-equalizing device is adapted to equalize a gap located at the writing pad.

3. The apparatus of claim 1, further comprising a stylus associated with the watertight main body.

4. The apparatus of claim 3, wherein the stylus is attached to the watertight main body by a string.

5. The apparatus of claim 1, wherein the auto-equalizing device includes ambient pressure to voltage gradient compensation.

6. The apparatus of claim 1, wherein the apparatus is adapted to function as a dive computer.

7. The apparatus of claim 1, further comprising means for alternating between a dive mode and a write mode.

8. The apparatus of claim 1, further comprising means for downloading the information to a personal computer.

9. The apparatus of claim 1, further comprising software for capturing site data and interpreting the information.

10. A method for capturing site data, the method comprising:
activating an apparatus, the apparatus includes: a watertight main body; a display screen disposed on the main body; and a writing pad incorporated as part of the display screen, wherein the writing pad receives information by applying a pressure to the writing pad and the writing pad has an auto equalizing device;
activating a write mode; and
applying pressure to the writing pad so as to input information.

11. The method of claim 10, further comprising deactivating the write mode.

12. The method of claim 10, further comprising operating a dive mode, the dive mode includes functions of a dive computer.

13. The method of claim 12, further comprising alternating between the dive mode and the write mode.

14. The method of claim 10, further comprising downloading the information to a personal computer.

15. The method of claim 10, further comprising interpreting the information.

16. The method of claim 10, further comprising selecting options.

17. A method for capturing site data, the method comprising:
activating an apparatus, the apparatus includes: a watertight main body; a display screen disposed on the main body; and a writing pad incorporated as part of the display screen, wherein the writing pad receives information by applying a pressure to the writing pad and the writing pad is adapted to function in a harsh environment;
alternating between a first mode and a second mode; and
inputting information through the writing pad.

18. The method of claim 17, further comprising downloading the information to a personal computer.

19. The method of claim 17, further comprising interpreting the information.

20. The method of claim 17, wherein the first mode is a dive mode and the second mode is a write mode.

21. The method of claim 17, further comprising selecting options.
